(19) United States
(12) Patent Application Publication
(10) Pub. No.: US 2015/0081547 A1
(43) Pub. Date: Mar. 19, 2015

(54) METHOD FOR PROTECTING ONLINE TRANSACTION SAFETY BETWEEN BUYERS AND SELLERS

(71) Applicant: GASH PLUS (TAIWAN) COMPANY LIMITED, New Taipei City (TW)

(72) Inventors: Jen-Chu PENG, New Taipei City (TW); Hsuan-Ying HAN, New Taipei City (TW)

(73) Assignee: GASH PLUS (TAIWAN) COMPANY LIMITED, New Taipei City (TW)

(21) Appl. No.: 14/098,625

(22) Filed: Dec. 6, 2013

(30) Foreign Application Priority Data
Sep. 18, 2013 (TW) 102133828

(51) Int. Cl. G06Q 20/02; G06Q 20/40

(52) U.S. Cl. CPC G06Q 20/02; G06Q 20/40
USPC 705/44

(57) ABSTRACT

The present invention is to provide a method for protecting online transaction safety between buyers and sellers, wherein, when a third-party server receives a good transaction information (including a first account information, a first good code and a selling price) from a first terminal device (seller), the third-party server sends the first good code to a verification unit to verify whether a good corresponding to the first good code has been used. If no, the first good code is locked. Then, the third-party server displays the good transaction information on a transaction platform and, when receiving a good purchasing message (including a second account information and the first good code) from a second terminal device (buyer) through the transaction platform, the third-party server deducts the selling price from the money corresponding to the second account information and adds the same to the money corresponding to the first account information accordingly.

### FIELD OF THE INVENTION

The present invention relates to an online transaction method, especially an online transaction method to ensure that virtual goods, software registration code or card, or point card verification password won't be maliciously used, and the buyers and sellers are able to get virtual goods and money respectively.

### BACKGROUND OF THE INVENTION

According to FIG. 1, the conventional online transaction system 1 for providing game goods includes a first terminal device 11, a second terminal device 12 and a third-party server 13. The third-party server 13 is set with a transaction platform, such as Treasure Transaction 8591 Website, for users to view the contents of goods on the transaction platform through the displays of the first terminal device 11 and second terminal device 12. The third-party server 13 is set with an account data 131 and a money data 132. The account data 131 includes a plurality of accounts, and the money data 132 includes a plurality of moneys. Each of the accounts corresponds to each of the moneys. To be specified, each account is the account that a user registered on the third-party server 13 in advance, and the user is able to store value in the third-party server 13 so that the registered account can correspond to the money added for subsequent transactions.

Referring to FIG. 1 again, when the seller wants to sell a point card, a good selling information can be sent to the third-party server 13 through the first terminal device 11, the good selling information includes the account information of the seller, such as the account name or an identification code representing the account, the name of the point card and a selling price. The third-party server 13 displays the point card selling information on the transaction platform after receiving the good selling information for others to search virtual goods through the transaction platform. When the buyer views the contents of the transaction platform though the second terminal device 12 and wants to buy the point card, a good purchasing message can be transmitted to the third-party server 13 through the transaction platform. The good purchasing message includes the buyer's account, the name of the point card and a purchasing price. When the third-party server 13 receives the good purchasing message, it will first determine whether the money corresponding to the buyer's account is sufficient to pay the purchasing price or not. If it is sufficient, the third-party server 13 deducts the purchasing price from the buyer's without paying the purchasing price the seller but freezing the money of the purchasing price and sending a notification to the first terminal device 11. Thereby, the seller knows that the point card has been sold. The seller can mail the point card to the buyer or directly gives the serial number on the point card to the buyer. When the buyer receives the point card, a transaction completed message will be sent to a third-party server 13 through the second terminal device 12. After the third-party server 13 receives the transaction completed message, the frozen money of the purchasing price is added to the buyer's account to make sure the buyer receives the seller's goods successfully.

However, referring to FIG. 1, the aforementioned online transaction method still has many problems. First of all, as for point card, once the buyer receives the physical card or the serial number of the point card, the transaction completed message will be sent directly through the second terminal device 12. Therefore, if the seller sold and received the money and uses the serial number of the point card online, it would lead to the buyer can't use the serial number of the point card. Furthermore, the buyer doesn't want to transmit the transaction completed information after a physical card or the serial number of the point card has been received after a long time, the seller can't receive the money, which results in many trade disputes. Therefore, how to design a better online transaction method to fix the aforementioned drawbacks has become an important topic for related online industries.

### SUMMARY OF THE INVENTION

One objective of the present invention is to provide a method for protecting online transaction safety between buyers and sellers. The method is applied to an online transaction system, wherein a third-party server receives a good transaction information (including a first account information, a first good code and a selling price) from a first terminal device. Then, the third-party server sends the first good code to the verification unit to verify whether a good corresponding to the first good code is in a state which means the good has been used. If no, the first good code is locked in a locked state. The third-party server displays the good transaction information on a transaction platform and, when receiving a good purchasing message (including a second account information and the first good code) from a second terminal device through the transaction platform, the third-party server deducts the selling price from the money corresponding to the second account information and sends a good transaction completed message to the verification unit. The verification unit generates a second good code to replace the first good code and transmits the second good code to the third-party server according to the good transaction completed message. Finally, the third-party server transmits the second good code to the second terminal device and adds the selling price paid from the money corresponding to the second account information to the money corresponding to the first account information. The whole online transaction is safely completed.

The second objective of the present invention is to provide a method for protecting online transaction safety between buyers and sellers. The method is applied to an online transaction system. The third-party server receives a good transaction information (including a first account information, a good information and a selling price). The third-party server sends the good information to a verification code unit to verify whether the good corresponding to the good information is correct or not. If yes, the good information is locked in a locked state, and a good code is generated according to the good information and sent to the third-party server. The third-party server displays the good transaction information on a transaction platform after receiving the good code. The third-party server deducts the selling price from the money corresponding to the second account information and sends a good code to the game company server. The game company server executes a shipping process according to the good code. The third-party server adds the selling price paid from the money corresponding to the second account information to the money corresponding to the first account information.

### BRIEF DESCRIPTION OF THE DRAWINGS

FIG. 1 is a schematic of the conventional online transaction system;

FIG. 2 is a schematic of the online transaction system of the first embodiment in accordance with the present invention;

FIG. 3 is the schematic of the account data and the money data of the first embodiment in accordance with the present invention;

FIG. 4 is a flow diagram of the first embodiment in accordance with the present invention and is divided into FIG. 4A and FIG. 4B connected to each other with circle A and circle B;

FIG. 5 is a schematic of the online transaction system of the first embodiment in accordance with the present invention; and

FIG. 6 is a first part of flow diagram of the first embodiment in accordance with the present invention and is divided into FIG. 6A and FIG. 6B connected to each other with circle A and circle B.

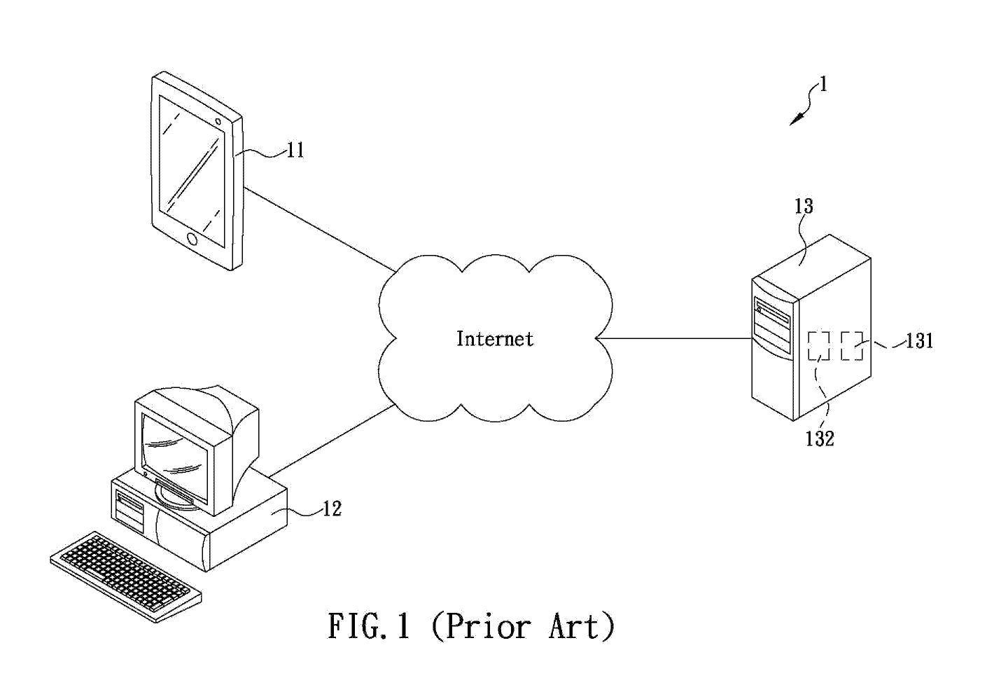

### DESCRIPTION OF THE PREFERRED EMBODIMENT

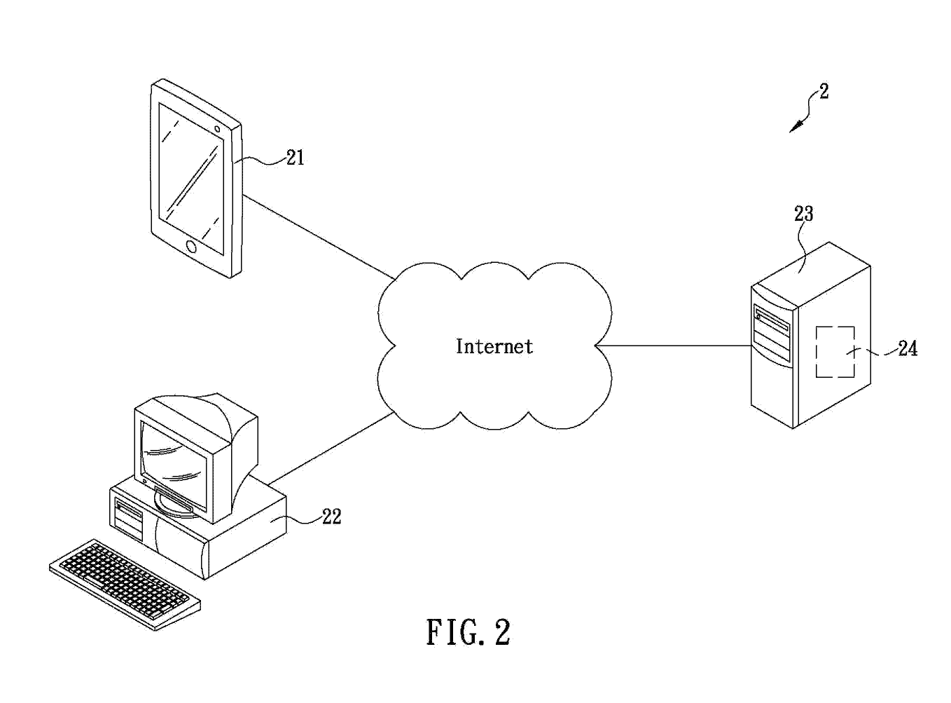

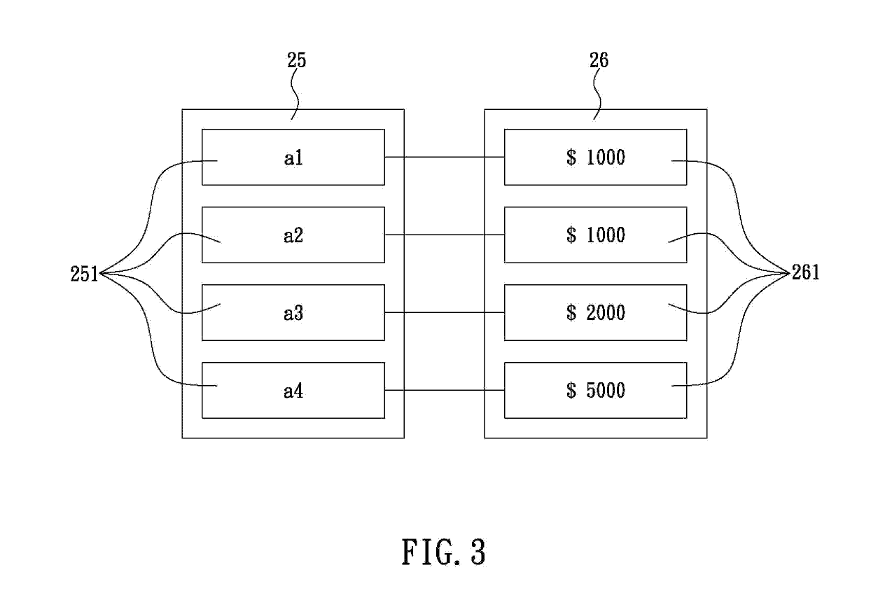

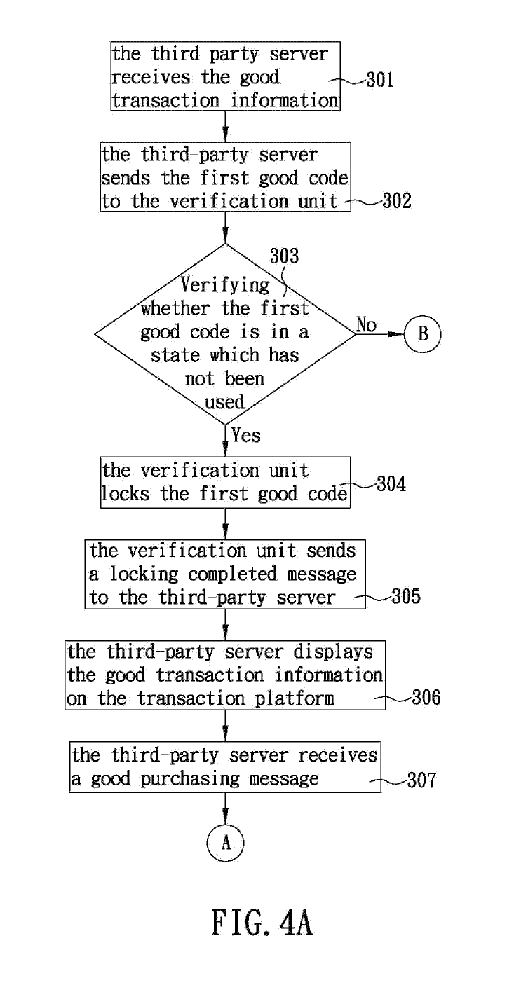

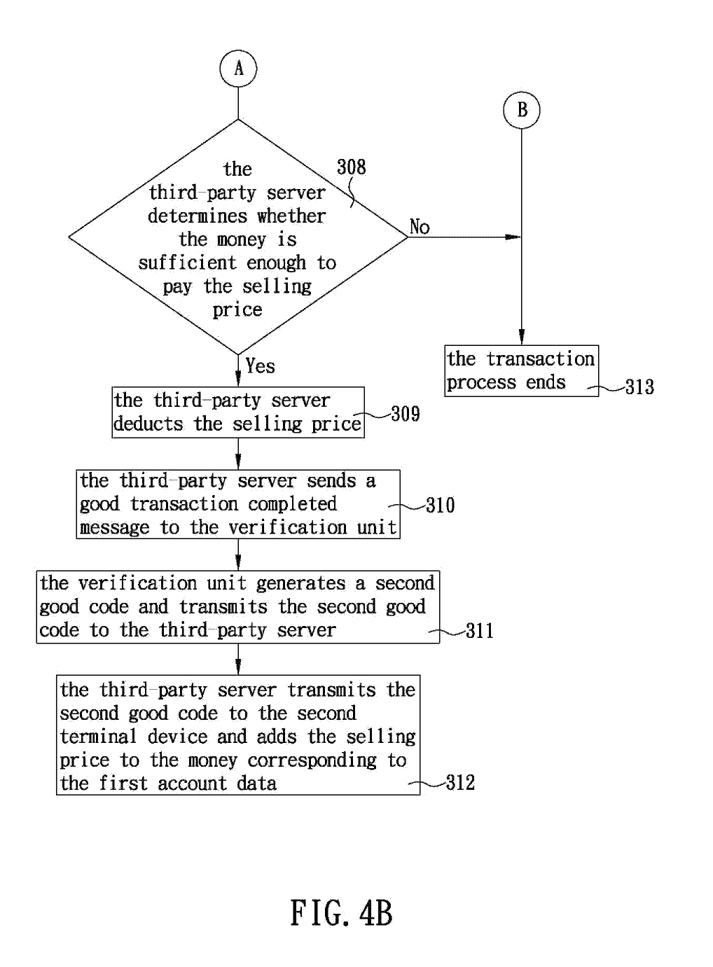

In the first embodiment of the present invention, please refer to FIG. 2. The method is applied to an online transaction system 2. The online transaction system 2 comprises a first terminal device 21, a second terminal device 22, a third-party server 23 and a verification unit 24. The verification unit 24 is located in the third-party server system 23. Referring to FIGS. 2 and 3, the third-party server 23 can be connected to the terminal devices 21, 22, respectively, over Internet. The terminal devices 21, 22 are set with an account data 25 and a money data 26. The account data 25 includes a plurality of accounts 251, such as a1˜a4. The money data 26 includes a plurality of moneys 261. For example: 1000, 1000, 2000, and 5000. Each of the accounts 251 corresponds to each of the moneys 261. For example, the a1 account 251 corresponds to the 1000 dollars money 261 and the a2 account 251 corresponds to the 1000 dollars money 261, etc. Furthermore, when a seller wants to sell the online game cards, a good transaction information is sent through the first terminal device 21. The good transaction information includes a first account information, a first good code (such as the serial number 123456 of the online game point card) and a selling price (such as 500 dollars). The first account information can be either the account 251 (a1 in this embodiment) registered by a seller or an identification code standing for the account 251 registered by the seller. Then, after the third-party server 23 receives the good transaction information transmitted from the first terminal device 21, the first good code will be sent to the verification unit 24.

The verification unit 24 can verify whether the good (i.e., the online game cards) corresponding to the first good code is in the state which means the good has been used yet. If no, the first good code is locked in the locked state, which means no one can use the good corresponding to the first good code before the first good code hasn't been unlocked. This is to ensure that the seller can not maliciously use the good during selling. The verification unit 24 sends a locking completed message to the third-party server 23 after locking the first good code. The third-party server 23 receives the locking completed message and then displays the good transaction information on a transaction platform, such as YAHOO auction, treasures transaction 8591, eBay, etc. The transaction platform is provided by third-party server 23 for the terminal devices 21, 22 to view the goods via the transaction platform. Furthermore, in other embodiments of the present invention, after the third-party server 23 receives the locking completed message, the first good code of the good transaction information is replaced with a first good name, such as point card, and then the good transaction information is displayed on the transaction platform. This avoids the situation that others may have obtained the first good code before the transaction hasn't completed and that the third-party server 23 are still capable of removing the first account information of the good transaction information and then displaying the good transaction information on the transaction platform.

When a buyer browses the good transaction information on the transaction platform and wants to buy the online game point card, a good purchasing message can be sent to the third-party server 23 by the second terminal device 22 through the transaction platform. The good purchasing message includes a second account information (i.e. the account 251 registered by the buyer. In this embodiment, it is a2 or the identification code standing for the account 251 registered by the buyer) and the first good code. After the third-party server 23 receives the good purchasing information, the money 261 corresponding to the second account information (the account 251 registered by the buyer, namely a2) is determined if it is enough to pay the selling price according to the account data 25 and the money data 26. Since the second account information (i.e. a2) corresponds to the money 261, which is 1000 dollars, so that the third-party server 23 will deduct the selling price from the money 261 corresponding to the second account information. It means that the money 261 corresponding to the second account information (i.e. a2) is changed to 500 dollars, and a good transaction completed message is sent to the verification unit 24. However, in other embodiments, if the first good code has been replaced with the first product name, the good purchasing message includes the second account information and the first good name.

The verification unit 24 generates a second good code, such as the serial number 654321 of the online game point card, to replace the first good code according to the good transaction completed message, and sends the second good code to the third-party server 23. The third-party server 23 sends the second good code to the second terminal device 22 and adds the selling price paid from the money corresponding to the second account information to the money 261 corresponding to the first account information. In other words, the money 261 corresponding to the first account information (the account 251 that the seller registered, namely a1) is changed to 1500 dollars in order to safely complete the entire online transaction. Therefore, although the seller can know first good code, the first good code will be in the locked state when the seller puts the good on sale. The first good code is later replaced by a second good code, and therefore, the seller can't maliciously use the first good code ensuring buyer can safely use the good (online game cards) corresponding to the second good code. In addition, the seller can get money quickly without waiting for the buyer sending the transaction completed message to a third-party server 23, and this effectively guarantees the online transaction rights for both buyers and sellers.

The processing procedures of the online transaction system 2 of the present invention are described below and please refer to FIGS. 2˜4A, 4B.

(301) the third-party server 23 receives the good transaction information transmitted from the first terminal device 21, proceeds to the step (302);

(302) the third-party server 23 sends the first good code to the verification unit 24, proceeds to step (303);

(303) the verification unit 24 verifies whether the good corresponding to the first good code is in a state which means the good has been used, if no, proceeds to step (304), otherwise goes to step (313);

(304) the verification unit 24 locks the first good code in the locked state, proceeds to step (305);

(305) the verification unit 24 sends a locking completed message to the third-party server 23, proceeds to step (306);

(306) the third-party server 23 displays the good transaction information on the transaction platform, proceeds to step (307);

(307) the third-party server 23 receives a good purchasing message from the second terminal device 22 through the transaction platform, proceeds to step (308);

(308) the third-party server 23 determines whether the money 261 corresponding to the second account information is sufficient enough to pay the selling price or not, and if yes, proceeds to step (309), otherwise, proceeds to step (313);

(309) the third-party server 23 deducts the selling price from the money 261 corresponding to the second account information, proceeds to step (310);

(310) the third-party server 23 sends a good transaction completed message to the verification unit 24, proceeds to step (311);

(311) the verification unit 24 generates a second good code to replace the first good code and transmits the second good code to the third-party server 23, proceeds to step (312);

(312) the third-party server 23 transmits the second good code to the second terminal device 22 and adds the selling price paid from the money corresponding to the second account information to the money 261 corresponding to the first account information;

(313) the transaction process ends.

The method of the present invention can be applied to goods similar to point card, such as coupons, software serial number, and other commodities. The second good code which the buyer gets is different from the first good code, but the second good code still correspond to the good of the first good code. Therefore, the buyer doesn't have to worry if the seller maliciously uses the good and the buyer can't get the normal usage right of the good after the transaction is completed. Meanwhile, the seller can get the money of the selling price of the good successfully. In addition, the verification unit 24 can also generate a second good code after locking the first good code and saves it to the third-party server 23. Thereby, the third-party server 23 can provide the second good code to the buyer immediately after the buyer's money is obtained without having to wait for subsequent conversion steps of the verification unit 24. The waiting time for transactions between buyers and sellers is shortened. After the third-party server 23 obtains the second good code, the second good code is not shown but the first good code (or the first good name) of the good purchasing message is displayed instead.

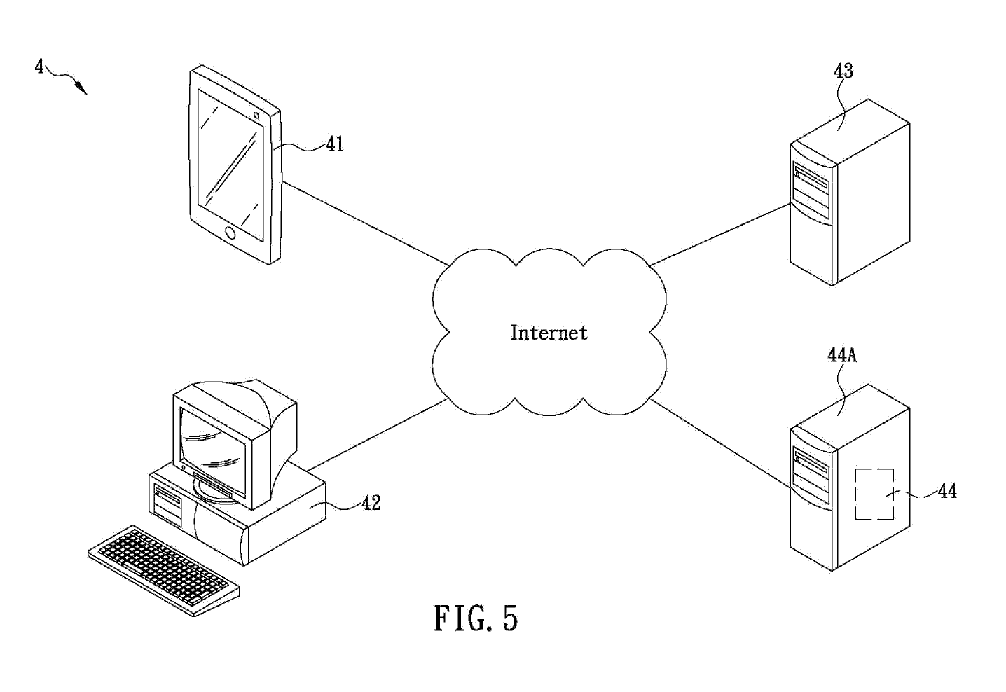

In addition to the aforementioned goods, the seller can also sell the good which doesn't have a good code, such as the game character of the online game. In the second embodiment of the present invention, as shown in FIG. 5, the online transaction system 4 includes a first terminal device 41, a second terminal device 42, a third-party server 43 and a game company server 44A. The game company server 44A is set with a verification unit 44. The third-party server 43 can be connected to the terminal devices 41, 43 and the game company server 44 through Internet, respectively. The terminal devices 41, 43 are set with an account data 25 and a money data 26. The account data 25 includes a plurality of account 251 as shown in FIG. 3. When the seller wants to sell the game character, a good transaction information will be sent through the first terminal device 41. The good transaction information includes a first account information (i.e. the account 251 registered by the seller, which is a3 in this embodiment, or an identification code standing for the account 251 registered by the seller), a good information, such as the game character's name, level, equipment, etc., and a selling price, such as 2000 dollars. When the third-party server 43 receives the good transaction information transmitted from the terminal device 41, the good information will be sent to the game company server 44A for the verification unit 44 to verify whether the good corresponding to the good information is correct or not. This means to determine whether the good information, such as the game character's name, level, equipment, etc., which was input by the seller matches with the information of the selling game character information or not. If yes, a good code is generated according to the good information, and the good corresponding to the good information is locked.

The verification unit 44 sends the good code to the third-party server 43 after locking the good information. The third-party server 43 displays the good transaction information on the transaction platform. When the buyer browses the good transaction information through the second terminal device 42 on the transaction platform and wants to buy the game character, a good purchasing message can be sent through the second terminal device 42 via the transaction platform to the third-party server 43. The good purchasing message includes a second account information (i.e. the account 251 registered by the buyer, it is a4 in the second embodiment, or the identification code standing for the account 251 registered by the buyer) and the good information. After the third-party server 43 receives the good purchasing message, the third-party server 43 further determines whether the money 261 corresponding to the second account information (the account 251 registered by the buyer, namely a4) is sufficient enough to pay the selling price or not according to the account data 25 and the money data 26. Since the money 26 corresponding to the second account information (i.e. a4) 5000 dollars, the third-party server 43 will deduct the selling price from the money 261 corresponding to the second account information and add the selling price to the money 261 corresponding to the first account information. At the same time, the good code would be sent to the game company server 44A. The game company server 44A executes a shipping process according to the good code. For example, the game company server 44A would unlock the good, such as a game character, corresponding to the good information and convert it to the buyer's game account.

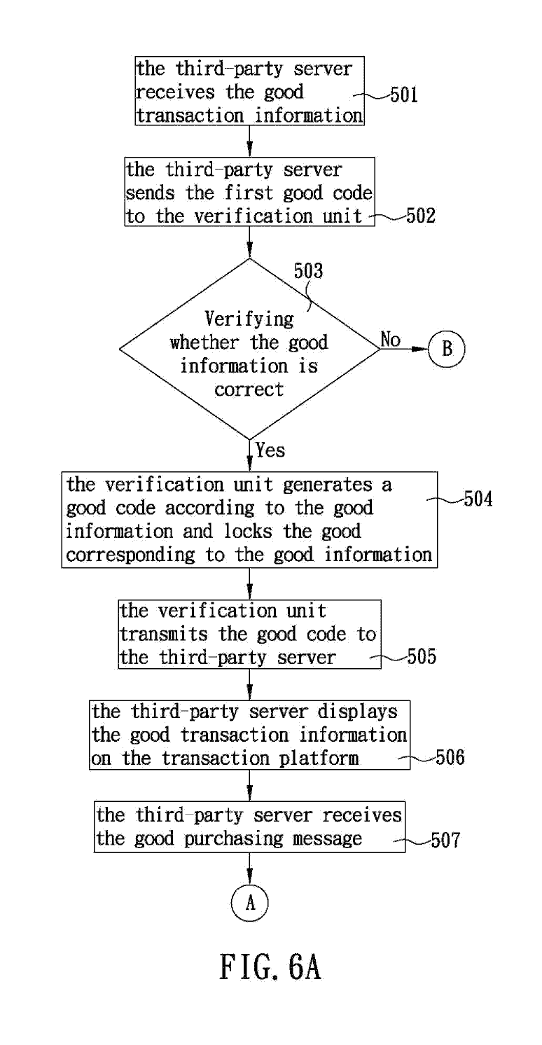

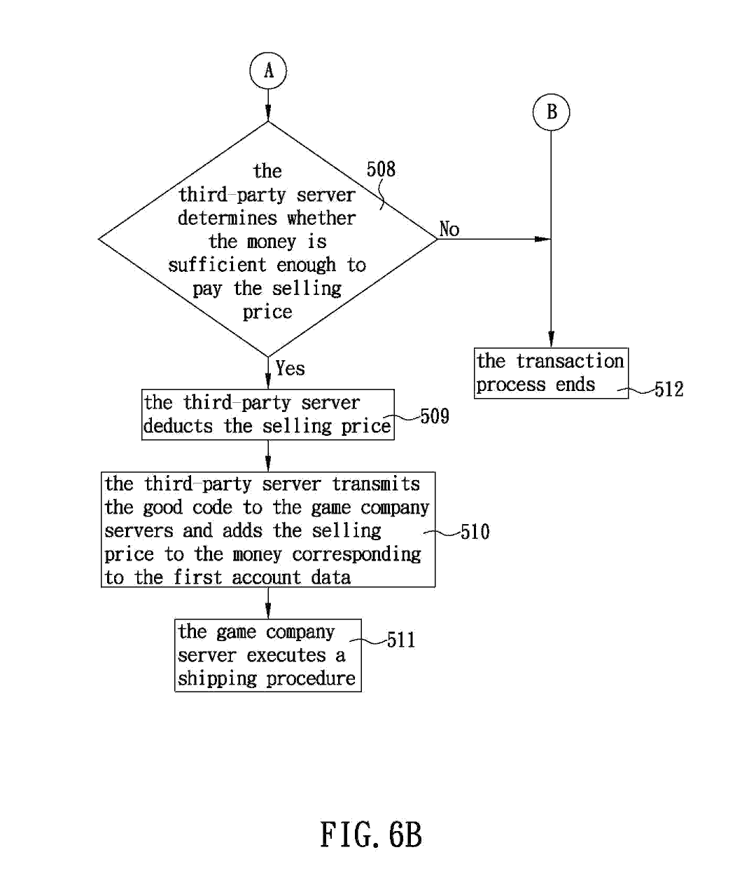

The processing procedures of the online transaction system 4 of the present invention are described below and please refer to FIGS. 3, 5, 6A, 6B.

(501) the third-party server 43 receives a good transaction information from the first terminal device 41, proceeds to step (502);

(502) the third-party server 43 sends the good information to the verification unit 44 of the game company server 44A, proceeds to step (503);

(503) the verification unit 44 verifies that the product corresponding to the information system of the product whether it is correct, if so, proceeds to step (504), otherwise goes to step (512);

(504) the verification unit 44 generates a good code according to the good information and locks the good corresponding to the good information in a locked state, proceeds to step (505);

(505) the verification unit 44 transmits the good code to the third-party server 43, proceeds to step (506);

(506) the third-party server 43 displays the good transaction information on the transaction platform, proceeds to step (507);

(507) the third-party server 43 receives the good purchasing message transmitted from the second terminal device 42 through the transaction platform, proceeds step (508);

(508) the third-party server 43 determines whether the money 261 corresponding to the second account information is sufficient enough to pay the selling price or not, and if yes, proceeds to step (509), otherwise, proceeds to step (512);

(509) the third-party server 43 deducts the selling price from the money 261 corresponding to the second account information, proceeds to step (510);

(510) the third-party server 43 transmits the good code to the game company servers 44A and adds the selling price paid from the money corresponding to the second account information to the money 261 corresponding to the first account information, proceeds to step (511);

(511) the game company server executes a shipping procedure;

(512) the transaction process ends.

With the aforesaid second embodiment, the virtual good bought by the buyer can be safely used for sure. For example, the game character's equipment will not be removed. This also ensures that the seller can get the required money after providing the virtual good. The online transaction rights of both the buyers and the sellers are effectively protected. Furthermore, before the game company server 44A executes the shipping procedure, the verification unit 44 can still verify the good code to ensure that the good code is correct. This avoids the situation that the good code is tampered with during the transmission. Secondly, the third-party server 43 is still capable of removing the first account information of the good transaction information and then displays the good transaction information on the transaction platform.

While the invention herein disclosed has been described by means of specific embodiments, numerous modifications and variations could be made thereto by those skilled in the art without departing from the scope of the invention set forth in the claims.

What is claimed is:

1. A method for protecting online transaction safety between buyers and sellers, the method being applied to an online transaction system, the online transaction system comprising a first terminal device, a second terminal device, a third-party server and a verification unit, the third-party server being connected to the terminal devices through Internet, respectively, each of the terminal devices being set with an account data and a money data, the account data having a plurality of accounts, the money data having a plurality of moneys, and each of the accounts corresponding to each of the moneys, the method being to make the online transaction system to execute the following steps of:
the third-party server receiving a good transaction information from the first terminal device, wherein the good information includes a first account information, a first good code and a selling price;
the third-party server sending the first good code to the verification unit;
the verification unit verifying whether the good corresponding to the first good code is in a state which means the good has been used, if no, locking the first good code in a locked state and sending a locking completed message to the third-party server; and
the third-party server displaying the good transaction information on a transaction platform after receiving the locking completed message.

2. The method as claimed in claim 1, further comprising the following steps of:
the third-party server receiving a good purchasing message transmitted from the second terminal device through the transaction platform, wherein the good purchasing message comprises a second account information and the first good code;
the third-party server determining whether the money corresponding to the second account information is sufficient enough to pay the selling price or not according to the account data and the money data, if yes, deducting the selling price from the money corresponding to the second account information and sending a good transaction completed message to the verification unit;
the verification unit generating a second good code to replace the first good code and transmitting the second good code to the third-party server according to the good transaction completed message; and
the third-party server transmitting the second good code to the second terminal device and adding the selling price paid from the money corresponding to the second account information to the money corresponding to the first account information.

3. The method as claimed in claim 1 wherein, after receiving the locking completed message and before displaying the good transaction information on the transaction platform, the third-party server replaces the first good code in the first good transaction information to a first good name.

4. The method as claimed in claim 1 wherein, after receiving the locking completed message and before displaying the good transaction information on the transaction platform, the third-party server deletes the first account information in the good transaction information.

5. The method as claimed in claim 3, further comprising the following steps of:
the third-party server receiving a good purchasing message transmitted from the second terminal device through the transaction platform, wherein the good purchasing message includes a second account information and the first good name;
the third-party server determining whether the money corresponding to the second account information is sufficient enough to pay the selling price or not according to the account data and the money data, if yes, deducting the selling price from the money corresponding to the second account information and sending a good transaction completed message to the verification unit;
the verification unit generating a second good code to replace the first good code and transmitting the second good code to the third-party server according to the good transaction completed message; and
the third-party server transmitting the second good code to the second terminal device and adding the selling price paid from the money corresponding to the second account information to the money corresponding to the first account information.

6. The method as claimed in claim 4, further comprising the following steps of:
the third-party server receiving a good purchasing message transmitted from the second terminal device through the transaction platform, wherein the good purchasing message includes a second account information and the first good name;
the third-party server determining whether the money corresponding to the second account information is sufficient enough to pay the selling price or not according to the account data and the money data, if yes, deducting the selling price from the money corresponding to the second account information and sending a good transaction completed message to the verification unit;
the verification unit generating a second good code to replace the first good code and transmitting the second good code to the third-party server according to the good transaction completed message; and
the third-party server transmitting the second good code to the second terminal device and adding the selling price paid from the money corresponding to the second account information to the money corresponding to the first account information.

7. A method for protecting online transaction safety between buyers and sellers, the method being applied to an online transaction system, the online transaction system comprising a first terminal device, a second terminal device, a third-party server and a verification unit, the third-party server being connected to the terminal devices through Internet, respectively, each of the terminal devices being set with an account data and a money data, the account data having a plurality of accounts, the money data having a plurality of moneys, and each of the accounts corresponding to each of the moneys, the method being to make the online transaction system to execute the following steps of:
the third-party server receiving a good transaction information from the first terminal device, wherein the good information includes a first account information, a first good code and a selling price;
the third-party server sending the first good code to the verification unit;
the verification unit verifying whether the good corresponding to the first good code is in a state which means the good has been used, if no, locking the first good code in a locked state, generating a second good code to replace the first good code and sending a locking completed message and the second good code to the third-party server; and
the third-party server displaying the good transaction information on a transaction platform after receiving the locking completed message and the second good code.

8. The method as claimed in claim 7, further comprising the following steps of:
the third-party server receiving a good purchasing message transmitted from the second terminal device through the transaction platform, wherein the good purchasing message comprises a second account information and the first good code;
the third-party server determining whether the money corresponding to the second account information is sufficient enough to pay the selling price or not according to the account data and the money data, if yes, deducting the selling price from the money corresponding to the second account information; and
the third-party server transmitting the second good code to the second terminal device and adding the selling price paid from the money corresponding to the second account information to the money corresponding to the first account information.

9. The method as claimed in claim 7 wherein, after receiving the locking completed message and the second good code and before displaying the good transaction information on the transaction platform, the third-party server replaces the first good code in the first good transaction information to a first good name.

10. The method as claimed in claim 7 wherein, after receiving the locking completed message and the second good code and before displaying the good transaction information on the transaction platform, the third-party server deletes the first account information in the good transaction information

11. A method for protecting online transaction safety between buyers and sellers, the method being applied to an online transaction system, the online transaction system comprising a first terminal device, a second terminal device, a third-party server and a game company server, the third-party server being connected to the terminal devices and the game company server through Internet, respectively, each of the terminal devices being set with an account data and a money data, the account data having a plurality of accounts, the money data having a plurality of moneys, and each of the accounts corresponding to each of the moneys, the game company server being set with a verification unit, the method being to make the online transaction system to execute the following steps of:
the third-party server receiving a good transaction information from the first terminal device, wherein the good information includes a first account information, a good information and a selling price;
the third-party server sending the first good code to the verification code unit;
the verification unit verifying whether the good corresponding to the good information is correct or not, if yes, locking the good information in a locked state, generating a good code according to the good information and sending a locking completed message to the third-party server; and
the third-party server displaying the good information and the selling price on a transaction platform after receiving the good code.

12. The method as claimed in claim 11, further comprising the following steps of:
the third-party server receiving a good purchasing message transmitted from the second terminal device through the transaction platform, wherein the good purchasing message comprises a second account information and the good information;
the third-party server determining whether the money corresponding to the second account information is sufficient enough to pay the selling price or not according to the account data and the money data, if yes, deducting the selling price from the money corresponding to the second account information and sending a good code to the game company server;
the game company server executing a shipping process according to the good code and adding the selling price paid from the money corresponding to the second account information to the money corresponding to the first account information.

13. The method as claimed in claim 12, wherein before the game company server executes the shipping process, the verification unit verifies the good code to whether the good code is correct or not, if yes, enabling the game company server to execute the shipping process.
